(19) United States
(12) Patent Application Publication
(10) Pub. No.: US 2013/0269861 A1
(43) Pub. Date: Oct. 17, 2013

(54) Adhesive Tape and it's Use as a Cable Bandaging Tape

(71) Applicant: Tesa SE, Hamburg (DE)

(72) Inventors: Patrik Kopf, Hamburg (DE); Thorsten Krawinkel, Hamburg (DE); Andreas Wahlers-Schmidlin, Guderhandviertel (DE)

(73) Assignee: Tesa SE, Hamburg (DE)

(21) Appl. No.: 13/898,195

(22) Filed: May 20, 2013

Related U.S. Application Data
(63) Continuation of application No. 12/944,360, filed on Nov. 11, 2010, now abandoned.
Application No. 12/944,360 is a division of application No. 12/141,501, filed on Jun. 18, 2008, now abandoned.

(30) Foreign Application Priority Data
Jul. 4, 2007 (DE) 10 2007 031 224.7

(51) Int. Cl. B29C 65/50

(52) U.S. Cl. CPC B29C 65/5007
USPC 156/185

(57) ABSTRACT

Adhesive tape intended more particularly for wrapping cables, comprising a textile backing and, coated on at least one side thereof, an adhesive comprising at least one vinylaromatic block copolymer and an at least partly hydrogenated tackifier resin.

The invention relates to an adhesive tape and to the use thereof for the bandaging of cables in the automotive sector.

Electrical and electromechanical components and the sheathing of electrical leads, frequently are composed of polymeric materials, with polyvinyl chloride (PVC) representing one important plastic, owing historically to its availability and to its excellent physicals properties and insulating properties. Sheathing on copper wires more particularly is composed predominantly of PVC or polyolefin, unless conditions such as high-temperature requirements force alternatives. In the past, self-adhesive tapes were developed for the mechanical and electrical protection of such cables, and are used generally and extensively for protecting and for insulating and also for bandaging, electrical leads and components. The self-adhesive tapes permit a long-term union to be produced without damage occurring to the cable as a result of interactions with adhesive tape and cable sheathing.

For special applications such as the wrapping of lengths of leads or cable looms in household appliances, machinery and, more particularly vehicles, furthermore, self-adhesive tapes which possess a textile backing, for example a woven polyester or viscose staple fabric, are widespread.

In discussions concerning the environmental compatibility of PVC, the trend is to replace this material by alternatives. Electrical components and accessories and also the sheathing of copper cables, are increasingly being produced with other plastics; for more stringent applications, besides fluoropolymers and thermoplastic elastomers, such as Amitel® [DSM Engineering Plastics] or Hytrel® [DuPont], polyester plastics are predominantly employed.

For the cost-sensitive mass-markets sector, with less stringent temperature requirements, the use of polyolefinic materials is on the increase, especially since the metallocene technology has made it possible to formulate profiles of mechanical properties similar to those of plasticized PVC; an additional factor is that the polyolefins per se exhibit outstanding insulating effects on the basis of their chemical composition as pure hydrocarbons.

For cable harnesses in vehicles as well, the trend is in favour of PVC-free leads of this kind, while components such as plug connections, switches, fluted tubes, etc. are already manufactured predominantly from PVC-free materials.

Lengths of electrical leads, or electrical components, which are wrapped with self-adhesive tapes must ensure reliable functioning over the entire lifetime of the product as a whole, such as that of a vehicle, for example. If unsuitable adhesive tapes are selected, it is possible during the life of the product for there to be instances of incompatibility, entailing damage to the cables or even extreme embrittlement. Corrosion and short circuits with the danger of failure of the entire electrical/electronic system, are possible consequences. Particularly in the case of vehicles such as cars or trucks, the requirements imposed on the compatibility are very exacting; in the passenger compartment there may be peak temperatures of up to 80° C., while in the engine compartment there are far higher sustained temperatures.

Consequently, for the field of use of the cable wrapping tapes, a long-term test over 3000 hours—of the kind, for example, described in the Automotive Testing Guideline LV 312—has become established as a standard test. It provides a particularly detailed check of the compatibility.

Sample cable harnesses are stored at the test temperatures and after specified periods of time, usually every 500 hours, are bent around a mandrel of defined diameter and then examined for damage. This test runs over a total time of 3000 hours. In some cases, purely visual inspection is supplemented by an electrical insulation test. The test temperatures are guided by the sectors in which the cable harnesses are employed and are 90° C. to 150° C., depending on the area of use of the cable loom in the passenger or engine compartment. The LV 312 test provides that for the temperature range T2 it is necessary that compatibility be ensured for an adhesive tape after 3000 hours at 105° C. Since in Europe the cables used in this temperature range are primarily cables with PVC sheathing, the test as well must be carried out with such cables. In the next higher temperature class, T3, cables with insulation of radiation crosslinked polyethylene and polypropylene are employed for the tests. Testing is carried out at 125° C. In addition to the leads from certain manufacturers that are used as reference leads in LV 312, the same test can also be carried out on leads which meet other international lead standards, such as, for example, the SAE J1128—TXL standard or the SAE J1128—TWP standard in the USA.

According to the LV 312 test method, in detail, the following specimen cable harnesses are produced. Two identical cores with a lead cross section of 0.35 mm² are twisted with a length of lay of approximately 2 cm. The bundled leads are wrapped helically with the adhesive tape under test (width 19 mm) with an approximately 50% overlap.

The leads used, for a test temperature of 105° C., are PVC leads (manufacturer's identifications: Gebauer & Griller 67218 or Coroplast 46443).

For a test temperature of 125° C., PP leads from Tyco (manufacturer's identification: AGP 0219) and XPE leads from Acome (manufacturer's identification: T4104F) or Draka (manufacturer's identification: 971130) are utilized.

The wrapped lead harnesses with the corresponding reference leads, and also an unwrapped blank sample, are stored freely hanging in an oven with natural ventilation for the duration of 3000 h at 105° C. or 125° C., respectively. Every 500 h a test sample is taken. The cable harness is conditioned under test conditions for at least 3 h, but not more than 48 h and then tested as follows:

A section of lead harness is wound around a 20 mm diameter mandrel and inspected. Then a voltage test is carried out in accordance with LV 112, “Measurement of the 1-minute voltage resistance” section. Thereafter the test sample is freed from the adhesive tape and untwisted. First of all the wrapping tape must be able to be detached without obvious damage to the lead.

Subsequently, the individual cores are tested. One individual core is wound tightly at least twice around a 2 mm diameter mandrel, the other around a 10 mm diameter mandrel, and they are each inspected and in each case a voltage test is carried out.

In the winding test of the individual cores around a 2 mm mandrel, they must not exhibit any cracks, breaks or embrittlement and must not have swollen or contracted. Discoloration of the lead is permissible. The original colour must still be in evidence. In the case of winding around the 10 mm mandrel, likewise, there must be no cracks, breaks or embrittlement and the cores must not have swollen or contracted.

Known for cable wrapping applications of this kind are adhesive tapes featuring a tape-like backing based on wovens or stitchbonded webs, with tapes having a stitchbonded web backing being described, for example, in DE 94 01 037 U1. As the adhesive coating it is preferred to use pressure-sensitive adhesive coatings.

To date, use has been made particularly of pressure-sensitive adhesives (PSAs) based on natural rubber and on styrene block copolymers. These natural rubber-based adhesives in particular show weaknesses in the LV 312 compatibility test, not only on PVC cable sheathing but also on polyolefinic cable sheathing. Since natural rubbers are processed primarily from solution, the production of these adhesive tapes is, as well, more expensive than that of those based on a material to be processed from the melt.

The adhesives used that are based on styrene block copolymers that can be processed from the melt without solvent only rarely, on cable types from specific manufacturers, achieve compatibility for the T2 temperature range on PVC cables in a 3000-hour test at 105° C., but not on all cables which meet the corresponding standards and are used for this application. There is damage to the cable insulation, with the consequence that, after winding around a mandrel, the insulation breaks and the free cable becomes visible. The spectrum of damage that occurs ranges from slight cracking in the cable sheathing as a result of embrittlement, through to complete failure due to fragmentation of components and cable sheathing after prolonged storage.

It is an object of the invention to remedy this situation and to provide an adhesive tape intended more particularly for use as a bandaging tape for cables, the intention being that the adhesive tape should have a PSA based on styrene block copolymers which can be processed more particularly from the melt.

This object is achieved by means of an adhesive tape as shown in the main claim. Advantageous developments of the subject matter of the invention and uses of the adhesive tape, are found in the dependent claims.

The invention accordingly provides an adhesive tape intended more particularly for wrapping cables, comprising a textile backing and, coated on at least one side thereof, an adhesive comprising at least one vinylaromatic block copolymer and an at least partly hydrogenated tackifier resin.

According to one preferred embodiment, the vinylaromatic block copolymer is a styrene block copolymer, more particularly a hydrogenated block copolymer.

Pressure-sensitive adhesives (PSAs) employed include those based on block copolymers containing polymer blocks formed from vinylaromatics (A blocks) such as styrene, for example, and blocks formed by polymerization of 1,3-dienes (B blocks) such as, for example, butadiene and isoprene or a copolymer of the two. It is also possible to use mixtures of different block copolymers. Preference is given to using products which are partly or fully hydrogenated.

The block copolymers may have a linear A-B-A structure. Likewise possible for use are block copolymers of radial architecture, and also star-shaped and linear multiblock copolymers. As a further component it is possible to use A-B diblock copolymers.

Instead of the polystyrene blocks it is also possible to utilize polymer blocks based on other aromatics-containing homopolymers and copolymers (preferably C₈- to C₁₂ aromatics) with glass transition temperatures of > approximately 75° C., such as aromatics blocks containing a-methylstyrene for example. Likewise possible for utilization are polymer blocks based on (meth)acrylate homopolymers and (meth)acrylate copolymers with glass transition temperatures of >+75° C. In this context it is possible to employ not only block copolymers which utilize as hard blocks exclusively those based on (meth)acrylate polymers but also block copolymers which utilize both polyaromatics blocks, polystyrene blocks for example, and poly(meth)acrylate blocks.

Instead of styrene butadiene block copolymers and styrene-isoprene block copolymers and/or their hydrogenation products, viz. styrene-ethylene/butylene block copolymers and styrene-ethylene/propylene block copolymers, it is likewise possible in accordance with the invention to utilize block copolymers and their hydrogenation products, which utilize further polydiene-containing elastomer blocks, such as copolymers of two or more different 1,3-dienes, for example. Possible for utilization in accordance with the invention, furthermore, are functionalized block copolymers such as maleic anhydride-modified or silane-modified styrene block copolymers, for example.

Typical use concentrations for the block copolymer are situated at a concentration in the range between 30% and 70% by weight, more particularly in the range between 35% and 55% by weight.

As further polymers it is possible for those based on pure hydrocarbons, such as unsaturated polydienes, for example, such as natural or synthetically produced polyisoprene or polybutadiene, chemically substantially saturated elastomers, such as saturated ethylene-propylene copolymers, a-olefin copolymers, polyisobutylene, butyl rubber, ethylene-propylene rubber, for example, and also chemically functionalized hydrocarbons such as halogenated, acrylate-containing or vinyl ether-containing polyolefins, for example, to be present, and these polymers may replace up to half of the vinylaromatics-containing block copolymers.

In accordance with one further preferred embodiment, the hydrogenated tackifier resin is a hydrogenated hydrocarbon resin.

Tackifiers used are tackifier resins which are compatible with the elastomer block of the styrene block copolymers and are at least partly hydrogenated.

Suitable tackifier resins include preferably partially or fully hydrogenated resins based on rosin or on rosin derivatives. It is also possible to obtain at least partly hydrogenated hydrocarbon resins, hydrogenated hydrocarbon resins for example by partial or complete hydrogenation of aromatics-containing hydrocarbon resins (for example Arkon P and Arkon M Series from Arakawa or Regalite Series from Eastman), hydrocarbon resins based on hydrogenated dicyclopentadiene polymers (for example Escorez 5300 Series from Exxon), hydrocarbon resins based on hydrogenated C₅/C₉ resins (Escorez 5600 Series from Exxon) or hydrocarbon resins based on hydrogenated C₅ resins (Eastotac from Eastman) and/or mixtures thereof.

Hydrogenated polyterpene resins based on polyterpenes can be used as well. Aforementioned tackifier resins can be used either alone or in a mixture.

As further additives it is possible typically to use light stabilizers, such as, for example, UV absorbers, sterically hindered amines, antiozonants, metal deactivators, processing auxiliaries, and end-block reinforcing resins.

Plasticizing agents such as, for example liquid resins, plasticizer oils or liquid polymers of low molecular mass, such as low-molecular-mass polyisobutylenes with molar masses <1500 g/mol (number average) or liquid EPDM types, for example, are typically employed.

Fillers such as, for example, silicon dioxide, glass (ground or in the form of beads), aluminium oxides, zinc oxides, calcium carbonate, titanium dioxide, carbon blacks, to name but a few, and also colour pigments and dyes, and also optical brighteners, can likewise be used.

It has emerged that the choice of ageing inhibitors likewise has a considerable influence on the compatibility of the adhesive with the cable insulation.

Styrene block copolymer-based PSAs are typically admixed with primary and secondary antioxidants in order to enhance their ageing stability. Primary antioxidants react with oxy and peroxy radicals, which can form in the presence of oxygen, and react with them to form less reactive compounds. Secondary antioxidants reduce, for example, hydroperoxides to alcohols. There is known to be a synergistic effect between primary and secondary ageing inhibitors, and so the protective effect of a mixture is frequently greater than the sum of the two individual effects. Primary antioxidants used on a standard basis in styrene block copolymer-based PSAs are very frequently sterically hindered phenols, which carry a 3-(p-hydroxyphenyl) propionic acid moiety or a 3-(o-hydroxyphenyl) propionic acid group, such as for example Irganox 1010, Irganox 1076, Irganox 259, Irganox 1035 and Irganox 1135 from Ciba Additive, Sumilizer BP 101 and Sumilizer BP 76 from Sumitomo or Hostanox O 10 and Hostanox O 16 from Clariant or Lowinox PP 35 and Lowinox PO 35 from Chemische Werke Lowi, to name but a few. Compounds which have shown themselves particularly suitable for suppressing the destruction of the cable insulation are mononuclear and/or polynuclear phenols which contain a benzyl thioether moiety positioned ortho and/or para to the phenolic OH group. Of preferential suitability are 4,6-bis(octylthiomethyl)-o-cresol and 4,6-bis(dodecylthiomethyl)-o-cresol, mononuclear phenols of the kind supplied, for example by Ciba under the brand name Irganox 1520 and Irganox 1726, respectively.

These can ideally be used in combination with secondary antioxidants.

The PSAs may be prepared and processed from solution, from dispersion, and from the melt. Preferred processes of preparation and processing take place from the melt. For the latter case, suitable preparation processes encompass not only batch processes but also continuous processes. Particular preference is given to the continuous manufacture of the PSA by means of an extruder with subsequent coating directly onto the target substrate with the adhesive at an appropriately high temperature.

As backing material it is possible to use all known textile backings such as a loop product or a velour, scrim, woven or knit, more particularly a PET filament woven or a nylon woven, or a nonwoven web; the term “web” embraces at least textile sheetlike structures in accordance with EN 29092 (1988) and also stitchbonded nonwovens and similar systems.

It is likewise possible to use spacer fabrics, including wovens and knits, with lamination. Spacer fabrics are matlike layer structures comprising a cover layer of a fibre or filament fleece, an underlayer and individual retaining fibres or bundles of such fibres between these layers, said fibres being distributed over the area of the layer structure, being needled through the particle layer, and joining the cover layer and the underlayer to one another. The retaining fibres needled through the particle layer hold the cover layer and the underlayer at a distance from one another and are joined to the cover layer and the underlayer.

Suitable nonwovens include, in particular, consolidated staple fibre webs, but also filament webs, meltblown webs, and spunbonded webs, which generally require additional consolidation. Known consolidation methods for webs are mechanical, thermal, and chemical consolidation. Whereas with mechanical consolidations the fibres are mostly held together purely mechanically by entanglement of the individual fibres, by the interlooping of fibre bundles or by the stitching-in of additional threads, it is possible by thermal and by chemical techniques to obtain adhesive (with binder) or cohesive (binderless) fibre-fibre bonds. Given appropriate formulation and an appropriate process regime, these bonds may be restricted exclusively, or at least predominantly, to the fibre nodal points, so that a stable, three-dimensional network is formed while retaining the loose open structure in the web.

Webs which have proven particularly advantageous are those consolidated in particular by overstitching with separate threads or by interlooping.

Consolidated webs of this kind are produced, for example, on stitchbonding machines of the “Malifleece” type from the company Karl Mayer, formerly Malimo, and can be obtained, from sources including the companies Naue Fasertechnik and Techtex GmbH. A Malifleece is characterized in that a cross-laid web is consolidated by the formation of loops from fibres of the web.

The backing used may also be a web of the Kunit or Multiknit type. A Kunit web is characterized in that it originates from the processing of a longitudinally oriented fibre web to form a sheetlike structure which has loops on one side and, on the other, loop feet or pile fibre folds, but possesses neither threads nor prefabricated sheetlike structures. A web of this kind too has been produced, for a relatively long time, for example on stitchbonding machines of the “Kunitvlies” type from the company Karl Mayer. A further characterizing feature of this web is that, as a longitudinal-fibre web, it is able to absorb high tensile forces in the longitudinal direction. The characteristic feature of a Multiknit web relative to the Kunit web is that the web is consolidated on both the top and bottom sides by virtue of the double-sided needle punching.

Finally, stitchbonded webs are also suitable as an intermediate to form an adhesive tape. A stitchbonded web is formed from a nonwoven material having a large number of stitches extending parallel to one another. These stitches are brought about by the incorporation, by stitching or knitting, of continuous textile threads. For this type of web, stitchbonding machines of the “Maliwatt” type from the company Karl Mayer, formerly Malimo, are known.

And then the Caliweb® is outstandingly suitable. The Caliweb® consists of a thermally fixed Multiknit spacer web with two outer mesh layers and an inner pile layer, which is arranged perpendicular to the mesh layers.

Also particularly advantageous is a staple fibre web which is mechanically preconsolidated in the first step or is a wet-laid web laid hydrodynamically, in which between 2% and 50% of the web fibres are fusible fibres, more particularly between 5% and 40% of the fibres of the web.

A web of this kind is characterized in that the fibres are laid wet or, for example, a staple fibre web is preconsolidated by the formation of loops from fibres of the web or by needling, stitching or air-jet and/or water-jet treatment.

In a second step, thermofixing takes place, with the strength of the web being increased again by the complete or partial melting of the fusible fibres.

The web carrier may also be consolidated without binders, by means for example of hot embossing with structured rollers, in which case pressure, temperature, dwell time, and embossing geometry can be used to control properties like strength, thickness, density, flexibility and the like.

Starting materials envisaged for the textile backings include, in particular, polyester, polypropylene, viscose or cotton fibres. The present invention is, however, not restricted to the stated materials; rather it is possible to use a large number of other fibres to produce the web, this being evident to the skilled worker without any need for inventive activity. Used in particular are wear-resistant polymers such as polyesters, polyolef ins, polyamides or fibres of glass or of carbon.

Also suitable as backing material is a backing comprising a laminate in which at least the layer bearing the adhesive is a textile layer. Applied to this layer there may be one or more further layers of any desired material, for example, paper (creped and/or uncreped), film (for example polyethylene, polypropylene or monoaxially or biaxially oriented polypropylene films, polyester, PA, PVC and other films), foam materials in web form (of polyethylene and polyurethane, for example), and also the stated textiles.

On the coating side it is possible for the surfaces of the backings to have been chemically or physically pretreated, and also for their reverse to have undergone an anti-adhesive physical treatment or coating.

The adhesive tape is formed by applying the adhesive wholly or partially to one or, where appropriate, both sides of the textile backing.

Coating may also take place in the form of one or more stripes in the longitudinal direction (machining direction), where appropriate in the transverse direction, but more particularly is full-area coating.

Furthermore, the adhesives may be applied in patterned dot format by means of screen printing, in which case the dots of adhesive may also differ in size and/or distribution; by gravure printing of lines which join up in the longitudinal and transverse direction; by engraved-roller printing; or by flexographic printing.

The adhesive may be in the form of domes (produced by screen printing) or else in another pattern such as lattices, stripes or zigzag lines. Furthermore, for example, it may also be applied by spraying, thus producing a more or less irregular pattern of application.

For the purposes of this invention the general expression “adhesive tape” embraces all sheetlike structures such as two-dimensionally extended films or film sections, tapes with extended length and limited width, tape sections, diecuts, labels and the like.

The adhesive tape of the invention is especially suitable for wrapping elongate material such as, more particularly, cables or cable harnesses.

With further preference the adhesive tape is used for wrapping elongate material, the adhesive tape being passed in an open or overlapping helical line around the elongate material.

With further preference the adhesive tape is used for wrapping elongate material, the elongate material being enveloped in axial direction by the tape.

Surprisingly it has been found that, as well as the elastomers used, the tackifier resins employed, more particularly also have a decisive influence on the compatibilities of the adhesives with the cable insulation. Hydrogenated tackifier resins have emerged as being particularly suitable, more particularly hydrogenated HC resins.

Hence, in accordance with a further advantageous development of the invention, the adhesive tape is used for wrapping elongate material such as, more particularly cables or cable harnesses, the adhesive tape, when bonding to cables with PVC sheathing and to cables with polyolefin sheathing, not destroying the same when an assembly of cables and adhesive tape, in accordance with LV 312, January 2006 edition, section 5.5, is stored at temperatures above 100° C. and for up to 3000 h and then the cables are bent around a mandrel.

With further preferably the adhesive tape is used for wrapping elongate material such as, more particularly cables or cable harnesses, the adhesive tape, when bonding to cables with PVC sheathing and to cables with polyolef in sheathing, not destroying the same when an assembly of cables and adhesive tape, in accordance with LV 312, January 2006 edition, section 5.5, is stored at temperatures above 125° C. and for up to 3000 h and then the cables are bent around a mandrel.

The invention is illustrated below by a number of examples, without thereby wishing to restrict the invention.

### EXAMPLES

A textile backing of the polyester filament woven type with a basis weight of 70 g/m², having 32 threads per cm in warp direction and 28 threads per cm in weft direction, is nozzle-coated with the following adhesives from the melt. The temperature load on the backing is reduced by means of a cooled backing roll. The coat weight is 65 g/m².

The composition of the adhesive is specified in each case in % by weight.

### Example 1

An adhesive of the following composition is coated onto the backing in the manner described above.

| | | |
|---|---|---|
| 45.6% | Vector 4113 | styrene-isoprene-styrene block copolymer from |
| | | Dexco with a styrene content of 15% by weight |
| | | and a diblock content of 20% by weight |
| 44.4% | Escorez 5600 | hydrogenated HC resin from Exxon with a |
| | | softening point at 100° C. |
| 9.5% | Ondina G 41 | medical white oil from Shell |
| 0.5% | Irganox 1726 | phenol antioxidant containing ortho and para |
| | | to the phenolic OH group a benzyl thioether |
| | | moiety, from Ciba |

In accordance with LV 312, January 2006 edition, section 5.5, the completed adhesive tape is wrapped around a cable with different forms of insulation and is stored at the corresponding temperature. Six such specimens are produced for each type of cable.

| | |
|---|---|
| PVC | 105° C. |
| Crosslinked PE | 125° C. |
| PP | 125° C. |

Every 500 hours, one of the wrapped cables is checked; the adhesive tape is unwrapped again and the cable is wound around a 10 mm diameter mandrel and a 2 mm diameter mandrel. Investigation takes place as to whether the insulation is damaged in this process.

In all cases there are no instances of damage to the insulation for a storage time of up to 3000 h, as required by LV 312.

### Example 2

| | | |
|---|---|---|
| 49.8% | Europrene | styrene-isoprene-styrene block copolymer from |
| | Sol T 9113 | Polimeri with a styrene content of 18% by |
| | | weight and a diblock content of 7% by weight |
| 46.2% | Regalite | hydrogenated HC resin from Eastman with a |
| | R 1100 | softening point of 100° C. |
| 3.5% | Ondina G 41 | |
| 0.5% | Irganox 1726 | |

Again, all of the cable insulation checked is unaltered.

### Example 3

| | | |
|---|---|---|
| 48.2% | Kraton G 1657 | styrene-ethylene/butylene-styrene block |
| | | copolymer from Kraton with 13% by weight |
| | | styrene and 36% by weight diblock content |
| 45.6% | Arkon P 90 | hydrogenated HC resin from Arakawa with a |
| | | softening point of 90° C. |
| 5.7% | Escorez 5040 | liquid HC resin from Exxon |
| 0.5% | Irganox 1010 | phenolic primary antioxidant from Ciba |

Here again, as with the previous examples, the cable insulation is intact after 3000 hours' storage.

### Counterexample 4

| | | |
|---|---|---|
| 45.6% | Vector 4113 | |
| 44.4% | Escorez 1310 | Non-hydrogenated HC resin from Exxon with a |
| | | softening point of 90° C. |
| 9.5% | Ondina G 41 | |
| 0.5% | Irganox 1726 | |

The PVC cables show the first cracks after just 500 hours' storage, the PE and PP insulation after only 1000 hours.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. A method for wrapping an elongate product comprising wrapping an elongate product with an adhesive tape, said adhesive tape comprising a textile backing and an adhesive comprising at least one vinylaromatic block copolymer, an at least partly hydrogenated tackifier resin, and at least one ageing inhibitor, wherein the ageing inhibitor comprises mononuclear and/or polynuclear phenols which contain a benzyl thioether moiety positioned ortho and/or para to a phenolic OH group.

15. The method according to claim 14 wherein the elongate product is a cable or cable harness.

16. The method according to claim 14 wherein the adhesive tape is wrapped in a helical line around the elongate product.

17. The method according to claim 14 wherein the elongate product is a cable or cable harness.

18. The method according to claim 14 wherein the adhesive tape is wrapped in an axial direction around the elongate product.

19. The method according to claim 14, wherein the vinylaromatic block copolymer is a styrene block copolymer.

20. The method according to claim 14 wherein the vinylaromatic block copolymer is a styrene-butadiene block copolymer, a styrene-isoprene block copolymer and/or a hydrogenation product of the aforementioned block copolymers.

21. The method according to claim 14, wherein the hydrogenated tackifier resin is a hydrogenated hydrocarbon resin.

22. The method according to claim 14, wherein the tackifier resins are selected from the group consisting of partially or fully hydrogenated resins based on rosin or on rosin derivatives, at least partly hydrogenated hydrocarbon resins hydrocarbon resins based on hydrogenated dicyclopentadiene polymers, hydrocarbon resins based on hydrogenated C₅/C₉ resins, hydrocarbon resins based on hydrogenated C₅ resins, hydrogenated polyterpene resins based on polyterpenes and mixtures thereof.

23. The method according to claim 14, wherein the ageing inhibitor comprises 4,6-bis(octylthiomethyl)-o-cresol or 4,6-bis(dodecylthiomethyl)-o-cresol.

24. The method according to claim 14, wherein the adhesive is processed from a melt.

24. The method according to claim 14, wherein the adhesive tape exhibits compatibility with the elongate product after 3000 hours at 105° C. in accordance with the Automotive Testing Guideline LV 312.
